(19) United States
(12) Patent Application Publication
(10) Pub. No.: US 2018/0180232 A1
(43) Pub. Date: Jun. 28, 2018

(54) 5V Safety Light

(71) Applicant: STEVEN JACKSON, HONG KONG (HK)

(72) Inventor: STEVEN JACKSON, HONG KONG (HK)

(21) Appl. No.: 15/391,869

(22) Filed: Dec. 28, 2016

(51) Int. Cl. F21S 8/00; F21L 4/00; F21V 23/06

(52) U.S. Cl. CPC F21S 8/035; F21V 23/06; F21L 4/00

(57) ABSTRACT

The 5V Safety Light is a low voltage lamp. This submission is a combination of different technologies together to make a product which is intrinsically safe and gives the versatility to be used internationally (USB compatible). These lamps work form 5 volt DC supply via USB x 1 watt this means no matter what happens, even the wire is cut, this lamp is totally safe and cannot give you an electrical shock.

### DETAILED DESCRIPTION OF THE INVENTION

This technology combines two elements 1) A very low voltage bulb or non-replaceable LED and 2) A power supply from a USB plug and socket arrangement on the base

These lights work from computers, power banks for mobile phones or even batteries to provide safe lighting. The power can come from

1/Rechargeable or non-rechargeable battery (commonly known as a power pack)
2/any device such as a computer
3/a power supply like those used with a smart phone or other mobile device this can be

a. USB

b. USB2.1

c. USBC

The light source is a custom made LED bulb or non-replaceable unit complete with protective resistor to limit forward voltage on the LED, this runs well below all standards for children's lamps. The light source can be 1, 2 or 3 watt (or greater depending upon the limits of LED material technology).

A plug and socket can be

a. micro USB

b. round jack plug

c. USBC

This is to stop the lamp failing on any children as the plug pull out of either the power supply or the back of the lamp.

The combination of these three features makes this design unique.

The current and voltage are so low they fall below some standards as they are intrinsically safe, unlike other systems using higher voltages as subject to being dangerous from a temperature , short circuit or risk of electric shock, even if you short circuit this system is it sate.

### BRIEF DESCRIPTION OF THE DRAWING

FIG. 1—Schematic View of 5 Volt System

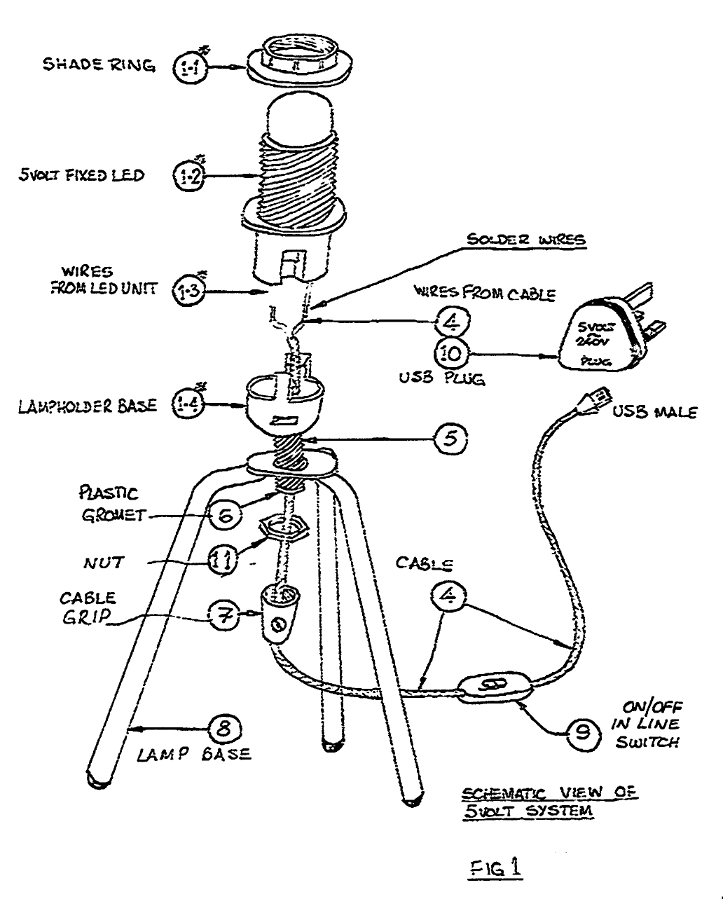

FIG. 2—Details of Replaceable 5V Bulb and Non-Replaceable 5V Unit

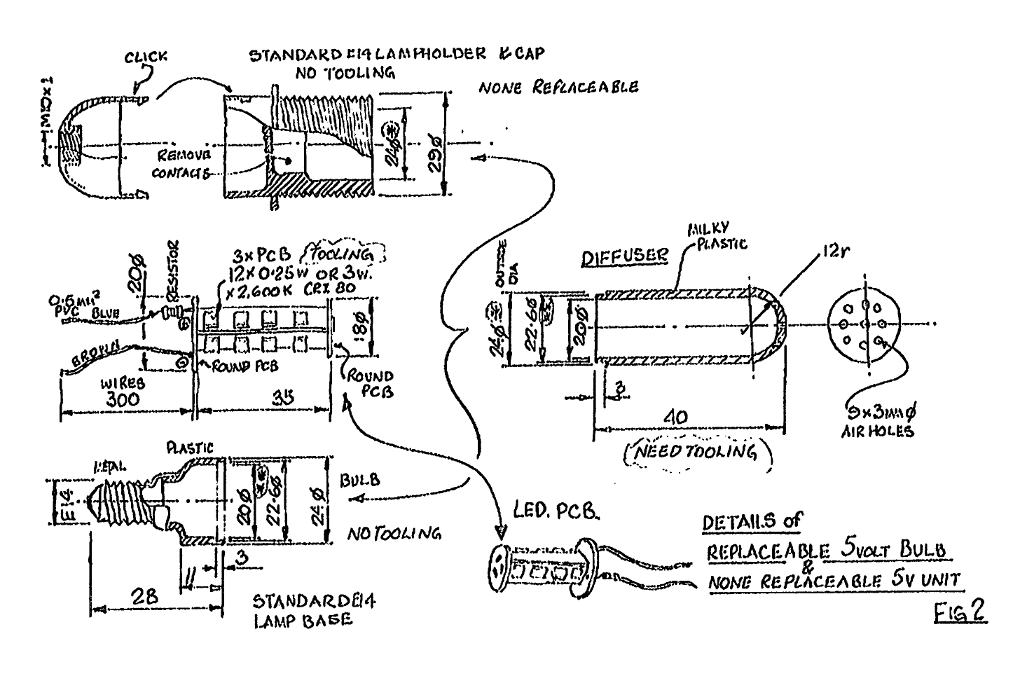

FIG. 3 Details of typical lamp with replaceable & None replaceable LED

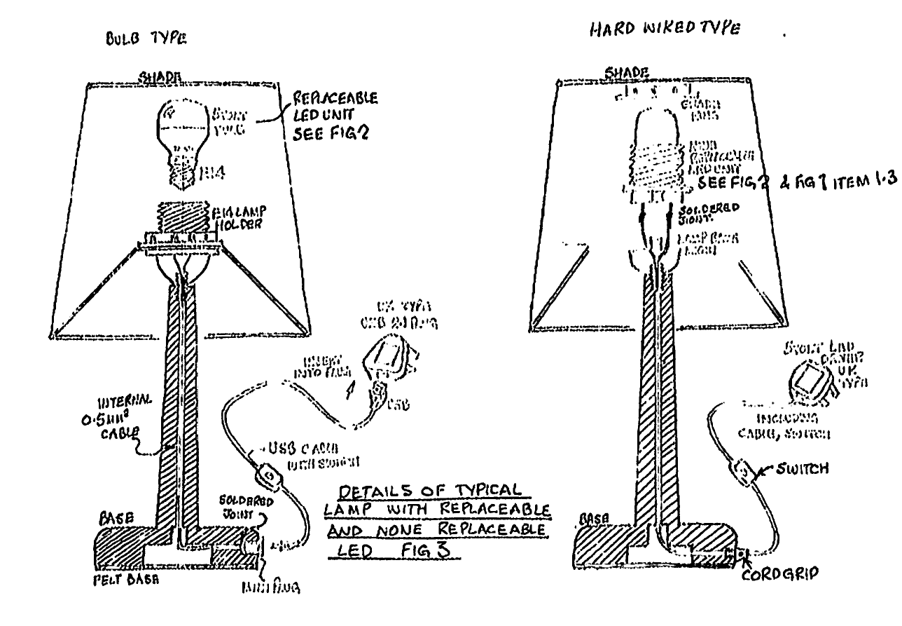

1. Applications include but not limited:
1/Children's Night Lights
2/Portable Torch or Flashlight

2. Invention claim of Unique and Exclusive utility is the application of a 5V power source to a low voltage LED light.
